(19) United States
(12) Patent Application Publication
(10) Pub. No.: US 2005/0025949 A1
(43) Pub. Date: Feb. 3, 2005

(54) Deformable veil and process for manufacturing same

(76) Inventor: Dale A. Grove, Pataskala, OH (US)

Correspondence Address: OWENS CORNING, 2790 COLUMBUS ROAD, GRANVILLE, OH, 43023, US

(21) Appl. No.: 10/914,919

(22) Filed: Aug. 10, 2004

Related U.S. Application Data
(63) Continuation-in-part of application No. 10/740,313, filed on Dec. 18, 2003.
Application No. 10/740,313 is a continuation-in-part of application No. 10/325,040, filed on Dec. 19, 2002.

(51) Int. Cl. B05D 3/02

(52) U.S. Cl. 428/292.1; 427/372.2

(57) ABSTRACT

An impregnated fibrous veil includes a fiber blend with between about 40 to about 60 weight percent glass fibers and about 40 to about 60 weight percent polyester fibers. The fiber blend is impregnated with a secondary binder formulation including a binder and expanded microspheres of thermoplastic resin material. A method for producing the impregnated fibrous veil is also provided.

This application is a continuation-in-part of U.S. patent application Ser. No. 10/740,313, filed Dec. 18, 2003, which is a continuation-in-part of U.S. patent application Ser. No. 10/325,040 filed Dec. 19, 2002, which is hereby incorporated by reference in its entirety.

### TECHNICAL FIELD AND INDUSTRIAL APPLICABILITY OF THE INVENTION

The present invention relates generally to a deformable veil suitable for the preparation of facers which cover curved and complex surfaces.

### BACKGROUND OF THE INVENTION

Fibrous webs or veils of intermingled, randomly oriented reinforcing fibers are well known in the art. Such veils have been used for a number of purposes. For example, U.S. Pat, No. 6,497,787 to Geel discloses a process for making a microsphere-filled wet-laid veil useful as a lightweight core reinforcement for GRP sandwich panel applications. In this process a formed veil is passed on a belt through a first belt dryer wherein a prebinder is bonded to the nonwoven fibrous veil to form a prebonded nonwoven fibrous veil. An impregnation binder liquid including microspheres is then applied to the prebonded nonwoven fibrous veil and subsequently dried in a second dryer. The microspheres improve the rigidity or impact resistance of articles reinforced with the resulting microsphere-filled wet-laid veil.

While the Geel '787 patent shows that the reinforcing fiber component of a veil may be any reinforcing fiber suitable for use in a wet-laid process including metal fibers, ceramic fibers, mineral fibers, glass fibers, carbon fibers, graphite fibers, polymer fibers, such as aramid, polyesters, polyacrylics, polyamides, polyacrylonitrile, natural fibers and combinations thereof, this patent explicitly teaches that glass fibers are preferred because of their ease of use and reinforcing properties. In fact, glass fibers comprise 100% of the reinforcing fibers utilized in the three examples explicitly provided in the '787 patent.

While the veil resulting from the process disclosed in the '787 patent provides improved rigidity and impact resistance and is particularly useful in reinforcing lightweight articles, the high concentration of glass fibers limits veil elongation and thus the ability of the veil to fold around curves and complex surfaces. Thus, the veil of the '787 patent cannot be effectively utilized for many applications. The present invention addresses this shortcoming and provides a fibrous veil with a fiber blend characterized by sufficient elongation to permit the veil to be folded around curves and to form complex surfaces. The veil produced in accordance with the present method is able to stretch significantly without breaking. This allows the present veil to be used in different applications not appropriate for the veil disclosed in the '787 patent including but not limited to acoustical facers, wall coverings, and other decorative facings.

### SUMMARY OF THE INVENTION

An impregnated fibrous veil is disclosed. The impregnated fibrous veil comprises a fiber blend including between about 40 to about 60 weight percent glass fibers and between about 40 to about 60 weight percent polyester fibers. The fiber blend is impregnated with a secondary binder formulation including a binder and expanded microspheres of thermoplastic resin material.

The glass fibers of the fiber blend have a diameter of between about 6.5 and about 15 microns and a length of between about 3 and about 10 mm. In a typical embodiment, the glass fibers are filaments having a diameter of about 11 microns and a length of about 6.35 mm. In one particularly useful embodiment, the fiber blend includes about 50 weight percent glass fibers and about 50 weight percent polyester fibers.

The polyester fibers are selected from a group of materials consisting of polyethylene terephthalate, polybutylene terephthalate and copolymers thereof. The polyester fibers typically have a length of between about 3 and about 10 mm with linear densities of about 0.1-10 decitex. In one possible embodiment, the polyester fibers have a length of about 6.35 mm. Further the polyester fibers may include bicomponent fibers.

The binder utilized in the binder formulation of the present invention is selected from a group of binders consisting of acrylic, styrene acrylonitrile, styrene butadiene rubber and mixtures thereof. The binder may also include a flame retardant. The flame retardant may be selected from a group of materials including a nitrogen phosphorous flame retardant, a phosphate flame retardant, aluminum trihydrate, magnesium hydroxide, calcium hydroxide, calcium carbonate, and mixtures thereof. Typically the overall binder formulation, which combines a polyvinylalcohol prebinder and a secondary post binder, includes between about 4 to about 10 weight percent polyvinylalcohol prebinder, 2 to about 15 weight percent secondary binder, 5 to about 20 weight percent microspheres, and 10 to about 30 weight percent flame retardant of the overall formulation; the remaining percentage consists of the fiber blend in the formulation.

The thermoplastic resin of the microspheres is selected from a group of resins consisting of acrylonitrile, polyvinylchloride, polyvinylidene chloride and mixtures thereof. Those microspheres have an unexpanded diameter of about 40 microns, and when heated expand to about 100-150 microns.

In accordance with yet another aspect of the present invention, a method of producing an impregnated fibrous veil is provided. The method comprises impregnating at least one face of a nonwoven fibrous veil including a prebinder and a fiber blend having between about 40 and about 60 weight percent glass fibers and between about 40 and about 60 weight percent polyester fibers with a binder formulation including a binder and expanded microspheres of thermoplastic resin material. The impregnating step includes applying the binder, formulation to at least one face of the nonwoven fibrous veil at a level between about 15 and about 70 g/m². The impregnating step also includes drying and consolidating the impregnated fibrous veil following the applying step.

Alternatively, the method of producing an impregnated fibrous veil may be defined as comprising the forming of a nonwoven fibrous veil precursor from a prebinder and a fiber blend of between about 40 and about 60 weight percent glass fibers and between about 40 and about 60 weight percent polyester fibers, the forming of a binder formulation, and the impregnating of the nonwoven fibrous veil precursor with the binder formulation in-line with the forming of the nonwoven fibrous veil precursor.

In the following description there is shown and described a preferred embodiment of this invention simply by way of illustration of one of the modes best suited to carry out the invention. As it will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWING FIGURES

The accompanying drawings incorporated in and forming a part of the specification, illustrate several aspects of the present invention, and together with the description serve to explain certain principles of the invention. In the drawings:

FIG. 1 is an edge on elevational view of a fibrous veil of the present invention; and

FIG. 2 is a schematical representation of the process for making that fibrous veil.

Reference will now be made in detail to the present preferred embodiment of the invention, an example of which is illustrated in the accompanying drawings.

### DETAILED DESCRIPTION AND PREFERRED EMBODIMENTS OF THE INVENTION

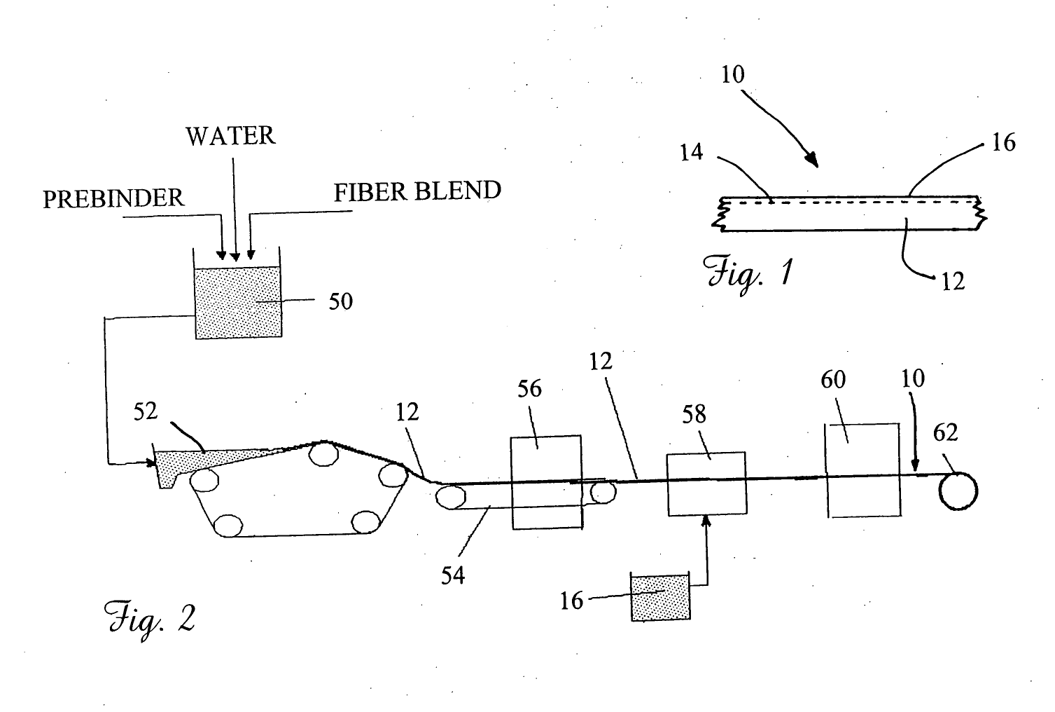

As illustrated in FIG. 1, the present invention relates to an impregnated fibrous veil 10 comprising a nonwoven fibrous veil 12 that is impregnated on at least one face 14 with a binder formulation 16 including a binder and expanded microspheres of thermoplastic resin material.

As used herein, the term “wet-laid fibrous veil” refers to a web of intermingled, randomly oriented reinforcing fibers made according to a wet-laid process. The “veil” of the present invention may also include “sheets” or “mats” made in accordance with the wet-laid process. The fibers are a blend of glass fiber filaments and polyester fibers. “Impregnating” or “impregnated” as used herein, refers to a means of integrating fillers into the fibrous veil. The method of impregnating may be conducted by any method suitable for integrating or incorporating these materials into the fibrous veil. In accordance with the present invention, the fillers are impregnated into the veil during a secondary impregnation step. In particular, the fillers are preferably impregnated after formation in a flooded nip section, which occurs after the precursor containing veil passes through a first dryer.

The “microspheres” of the present invention are particles of thermoplastic resin material, which may have incorporated therein a chemical or physical blowing agent (e.g. isobutane, isopentane), and which are expanded upon heating. The microspheres of the present invention have an expanded diameter of between about 100 and about 150 microns. The microspheres are utilized in their expanded state.

As previously noted, the impregnated fibrous veil 10 of the present invention comprises a nonwoven wet-laid fibrous veil 12 comprising a fiber blend and a prebinder. The fiber blend includes between about 40 and about 60 weight percent glass fibers and between about 40 and about 60 weight percent polyester fibers. A typical blend is about 50 percent glass fibers and about 50 percent polyester fibers.

The glass fibers have a diameter of between about 6.5 and 15 microns and a length between about 3 and about 10 mm. Typical glass fibers are filaments having a diameter of about 11 microns and a length of about 6.35 mm. Suitable glass fibers include any type of glass fiber, including, but not limited to A-type glass fibers, C-type glass fibers, E-type glass fibers, S-type glass fibers, and modifications thereof.

The polyester fibers are selected from a group of materials consisting of polyethylene terephthalate, polybutylene terephthalate and copolymers thereof. The polyester fibers have a density of about 1.1 g/cm³. Further the polyester fibers have a length of between about 3 and 10 mm with a linear density of about 0.1-10 decitex. Typical polyester fibers have a length of about 6.35 mm and a 1.7 decitex linear density. The polyester fibers may also be bicomponent fibers if desired.

The prebinder includes thermoplastic bonding fibers. Thermoset prebinders do not work since these resins do not melt and allow sufficient microsphere expansion. The expansion of these particles provide for unique textured aesthetics. Note that the prebinder may also include bicomponent fibers. The prebinder may be selected from a group of materials consisting of water soluble binders or emulsion type binders, such as polymers and copolymers of styrene, butadiene, acrylic and methacrylic monomers, vinyl acetate as well as polyesters, polyvinyl alcohols and mixtures thereof. Generally, the nonwoven fibrous veil comprises from about 70 to about 95 percent by weight fiber blend and about 5 to about 30 percent by weight prebinder.

As previously noted, at least one face 14 of the nonwoven wet-laid fibrous veil 12 is impregnated with the secondary binder formulation 16 including a binder and expanded microspheres of thermoplastic resin material. The binder is selected from a group of binders consisting of acrylic, styrene acrylonitrile, styrene butadiene rubber and mixtures thereof. The binder may further include a flame retardant. That flame retardant may be selected from a group of materials including but not limited to nitrogen phosphorous flame retardant, a phosphate flame retardant, aluminum trihydrate, magnesium hydroxide, calcium hydroxide, calcium carbonate and mixtures thereof. Typically the secondary binder formulation 16 combines 10 to about 30 weight percent binder, 25 to about 40 weight percent microspheres, and 25 to about 50 weight percent flame retardant.

The binder composition may optionally contain conventional additives such as dyes, oils, fillers, thermal stabilizers, emulsifiers, anti-foaming agents, anti-oxidants, organosilanes, colorants, UV stabilizers, and/or other conventional additives. Other additives may be added to the binder composition for the improvement of process and product performance. Such additives include coupling agents (e.g., silane, aminosilane, and the like), dust suppression agents, lubricants, wetting agents, surfactants, antistatic agents, and/or water repellent agents.

The thermoplastic resin of the microspheres is selected from a group of resins consisting of acrylonitrile, polyvinylchloride, polyvinylidene chloride and mixtures thereof. The microspheres have an expanded diameter of between about 100 and about 150 micron.

The process of manufacturing the fibrous veil 10 of the present invention is illustrated in FIG. 2. In the illustrated wet-lay process, the fiber blend, prebinder and water are agitated in a mixing tank 50 to provide an aqueous fiber slurry. The fiber blend is used as filaments. Additional elements to make up the aqueous slurry may be added as is known in the art. For example, antistatic agents, coupling agents, pigments, surfactants, anti-foams, colorants and fillers may be provided along with the prebinder into the slurry.

As illustrated in FIG. 2 the aqueous fiber slurry is transferred from the mixing tank 50 onto a suitable forming apparatus 52. The forming apparatus 52 may, for example, take the form of a moving screen or forming wire on an inclined wire forming machine, wire cylinders, Foudrinier machines, Stevens Former, Roto Former, Inver Former or Venti Former machines. Preferably, the formation of the veil 12 is on an inclined wire forming machine. The fibers and the additional slurry elements in the aqueous fiber slurry enmesh themselves into a freshly prepared wet laid fibrous veil 12 on the forming apparatus 52 while excess water is separated therefrom. The dewatering step may be conducted by any known method such as by draining, vacuum, etc. The water content of the veil after dewatering and vacuum is preferably in the range of about 40 to about 70%.

After the wet-laid nonwoven fibrous veil 12 is formed, the veil is transferred to a transport belt 54. The belt 54 carries the veil 12 into a means 56 for substantially removing the water. The removal of water may be conducted by known web drying methods, including the use of a rotary/through air dryer or oven, a heated drum dryer, an infrared heating source, hot air blowers, microwave emitting source and the like. At least one method of drying is necessary for removing the water but a plurality of these methods may be used in combination to remove the water and dry the wet laid fibrous veil 12. The temperature of the dryer may range from about 120 degrees C. at the start until about 210 degrees C. at the end of the first drying process. The air speed may be in the range of about 0.5 to 1 m/s. During drying the prebinder is bound to the reinforcing fibers in order to prebond the veil 12.

A face 14 of the prebonded veil 12 is then impregnated with the binder formulation 16. Any method suitable for impregnating the face 14 of the prebonded veil 12 may be used. For example, suitable methods include using a size press 58, such as a Foulard applicator, dipping roll, flooded nip, and the like. While other additional agents or coatings may be applied, preferably only the binder formulation 16 is contacted with the prebonded veil 12. Following the impregnation of the face 14 of the prebonded veil 12 with the binder formulation 16, is the drying and consolidating of the impregnated fibrous veil 10. Thus the now impregnated veil 10 is dried in a second dryer 60 which is preferably an airfloat oven. The resulting impregnated fibrous veil 10 is then collected on a winder 62.

The veil 10 of the present invention may be used as facers for ceiling tiles, wall coverings, and general decorative veils. The unique texture of the finished product and relatively soft touch make the material aesthetically desireable. The relatively high polyester content of the fiber blend increases the elongation of the veil 10 so that it may be readily folded around curves to form complex shapes without breaking. The flame retardant binder maintains reasonable flame retardancy in the final product. Depending upon the application, added flame retardancy is possible by employing a chlorine containing microsphere in combination with more flame retardants.

The following examples are representative but are in no way limiting as to the scope of this invention.

### EXAMPLE 1

A 60 grams per square meter precursor veil consisting of (a) an 89% fiber blend including about 45% glass fibers (diameter 11 micron, length 6 mm) and about 45% polyester fibers (linear density 1.7 decitex, length 6 mm) and (b) 11% polyvinylalcohol prebinder is formed using a wet-laid process using an inclined wire former. This precursor veil is fed to a belt dryer and dried and cured to form a prebonded sheet. The sheet is subsequently in-line impregnated with a binder formulation using a flooded nip application. The binder formulation consists of 9.3% Acronal LR8998, 1.7% of a Tego defoamer solution, 0.2% Leucophour UO (an optical brightener), 33.6% Bemiflame GF (nitrogen phosphourous flame retardant), 0.8% Zerostat FC (antistatic), 19% Exancel 054 microspheres, with the remaining percentage being water. The binder adds on approximately 20 grams per square meter. The impregnated sheet is then fed to an airfloat over to dry the sheet and expand the microspheres. Depending on the speed, the temperature used is between 130 and 200° C.

### EXAMPLE 2

A 60 grams per square meter precursor veil consisting of (a) an 89% fiber blend including about 45% glass fibers (diameter 11 micron, length 6 mm) and about 45% polyester fibers (linear density 1.7 decitex, length 6 mm) and (b) 11% polyvinylalcohol prebinder is formed using a wet-laid process using an inclined wire former. This precursor veil is fed to a belt dryer and dried and cured to form a prebonded sheet. The sheet is subsequently in-line impregnated with a binder formulation using a flooded nip application. The binder formulation consists of 13% Airflex CE35, 23.5% Bemiflame GF (nitrogen phosphourous flame retardant), 0.1% Leucophour UO (optical brightener), 25% Exancel 461 slurry (25% microspheres), with the remaining percentage being water. The binder adds on approximately 65 grams per square meter in this case to create a loftier product. The impregnated sheet is then fed to an airfloat over to dry the sheet and expand the microspheres. Depending on the speed, the temperature used is between 130 and 200° C.

In addition, while it is preferred that the secondary binder formulation 16 is applied inline to the prebonded fibrous veil 12, it does not have to be. Further, while the process as illustrated in FIG. 2 relates to the application of the binder formulation 16 to only one face 14 of the veil 12, it should be appreciated that it may be applied to both, opposing faces. Thus, the veil 12 may be brought into the Foulard applicator to assure that the prebonded veil 12 is wetted on both sides. This may be done by bringing the veil into the applicator from above in a double roll system, wherein surface finish formulation is capable of coating both sides/faces of the veil. Subsequently, the impregnated veil 10 is dried and/or cured in an oven or other drying device.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. An impregnated fibrous veil, comprising:
a fiber blend including between about 40 to about 60 weight percent glass fibers and between about 40 to about 60 weight percent polyester fibers; and
said fiber blend being impregnated with a secondary binder formulation including a binder and expanded microspheres of thermoplastic resin material.

2. The impregnated fibrous veil of claim 1, wherein said glass fibers have a diameter between about 6.5 and about 11 microns and a length between about 3 and about 10 mm.

3. The impregnated fibrous veil of claim 1, wherein said glass fibers are filaments having a diameter of about 11 microns and a length of about 6.35 mm.

4. The impregnated fibrous veil of claim 1, wherein said polyester fibers are selected from a group of materials consisting of polyethylene terephthalate, polybutylene terephthalate and copolymers thereof.

5. The impregnated fibrous veil of claim 4, wherein said polyester fibers have a length of between about 3 and about 10 mm with a linear density ranging from 0.1-10 decitex.

6. The impregnated fibrous veil of claim 5, wherein said polyester fibers have a length of about 6.35 mm.

7. The impregnated fibrous veil of claim 1, wherein said polyester fibers are bicomponent fibers.

8. The impregnated fibrous veil of claim 1, wherein said binder is selected from a group of binders consisting of acrylic, styrene acrylonitrile, styrene butadiene rubber and mixtures thereof.

9. The impregnated fibrous veil of claim 7 wherein said binder further includes a flame retardant.

10. The impregnated fibrous veil of claim 9, wherein said flame retardant is selected from a group of materials including a nitrogen phosphorous flame retardant, phosphate flame retardant, aluminum trihydrate, magnesium hydroxide, calcium hydroxide, calcium carbonate, and mixtures thereof.

11. The impregnated fibrous veil of claim 7, wherein said secondary binder formulation includes between about 10 to about 30 weight percent binder, 25 to about 40 weight percent microspheres, and 25 to about 50 weight percent flame retardant.

12. The impregnated fibrous veil of claim 1, wherein said thermoplastic resin of said microspheres is selected from a group of resins consisting of acrylonitrile, polyvinylchloride, polyvinylidene chloride and mixtures thereof.

13. The impregnated fibrous veil of claim 12, wherein said microspheres have an expanded diameter of between about 100 to 150 microns.

14. A method of producing an impregnated fibrous veil, comprising:
impregnating at least one face of a nonwoven fibrous precursor veil including a prebinder and a fiber blend having between about 40 and about 60 weight percent glass fibers and between about 40 and about 60 weight percent polyester fibers with a secondary binder formulation including a binder and expanded microspheres of thermoplastic resin material.

15. The method of claim 14, wherein said impregnating step includes applying said binder formulation to said at least one face of said nonwoven fibrous veil at a level between about 10 to 70 g/m².

16. The method of claim 15, wherein said impregnating step includes drying and consolidating said impregnated fibrous veil following said applying step.

17. A method of producing an impregnated fibrous veil, comprising:
forming a nonwoven fibrous veil from a prebinder and a fiber blend of between about 40 and about 60 weight percent glass fibers and between about 40 and about 60 weight percent polyester fibers;
forming a secondary binder formulation;
impregnating said nonwoven fibrous veil precursor with said binder formulation in-line with said forming of said nonwoven fibrous veil.

18. An impregnated fibrous veil, comprising between about 4 and about 10 weight percent prebinder, about 2 and about 15 weight percent secondary binder, about 5 and about 20 weight percent microspheres and about 10 and about 30 weight percent flame retardant and the remainder a fiber blend of from about 40 to about 60 weight percent glass fibers and about 40 to about 60 weight percent polyester fibers.

19. The impregnated fibrous veil of claim 18, wherein said polyester fibers are selected from a group of materials consisting of polyethylene terephthalate, polybutylene terephthalate and copolymers thereof.

20. The impregnated fibrous veil of claim 18, wherein said polyester fibers are bicomponent fibers.

21. The impregnated fibrous veil of claim 18 wherein said binder further includes a flame retardant.
